(19) United States
(12) Patent Application Publication
(10) Pub. No.: US 2009/0165648 A1
(43) Pub. Date: Jul. 2, 2009

(54) Method and Apparatus for Electrostatically Charging and Separating Particles That Are Difficult to Separate

(75) Inventors: Werner Jakob Frank, Bergisch-Gladbach (DE); Helga Frank, Bergisch Gladbach (DE)

Correspondence Address: BAKER & HOSTETLER LLP, WASHINGTON SQUARE, SUITE 1100, 1050 CONNECTICUT AVE. N.W., WASHINGTON, DC, 20036-5304, US

(73) Assignee: BALCKE-DURR GMBH, Oberhausen (DE)

(21) Appl. No.: 11/794,960

(22) PCT Filed: Jan. 9, 2006
(86) PCT No.: PCT/EP06/00106

§ 371 Date: Jul. 9, 2008

(30) Foreign Application Priority Data
Jan. 11, 2005 (EP) 05000380.5

(51) Int. Cl. B03C 3/38; B03C 3/00; B03C 3/41; B03C 3/155

(52) U.S. Cl. 95/73; 95/79; 96/59; 96/16

(57) ABSTRACT

The subject matter of the invention are electrostatic filter method and electrostatic filter for separating particles from industrial waste gases, whereas an optimal electric charging or ionization in the ionization zone are performed in a high-voltage zone and its unchanged ducts with one high-voltage supply source to ensure the subsequent particle separation in the separation zone at sufficient field strength which requires minimal energy input.

The subject matter of the invention is a method and apparatus for electrostatically charging and separating particles that are difficult to separate from a gas fluid according to the preambles of the independent claims 1 and 5. In other words, it concerns an electrostatic filter, and especially such an electrostatic filter methods or electrostatic filters which are suitable for filtering industrial waste gases.

In the case of electrostatic filters for dust separation in industrial waste gases which operate according to the so-called Cottrell principle and which can also be designated as electrostatic separating apparatuses, the changing and transport of the particles to be separated and their depositing on optionally specially formed collecting electrodes occur simultaneously in an electric field, with the particles, after sufficient accumulation or agglomeration, being removed from the collecting electrode either by mechanical vibration (dry dedusting) or by rinsing (wet dedusting). If necessary, several of the aforementioned electric fields are switched in series or also in parallel in order to achieve the desired total separating output.

The reason that some particles are difficult to separate may be caused by the electric properties of the particles which as a result of their chemical and physical properties lead to an insulating layer on the collecting electrode. An additional factor is that as a result of the electric flow turbulence or the so-called electric wind at high current density the share of particles in the grain range <10 μm can be deposited only with more difficulty on the collecting electrode in the region between the charging and the separating electrodes as a result of gas ionization. It is known that as a result of the physically effective charging mechanisms, namely the so-called surge or field charging and the diffusion charging, a more or less strong minimum of particle fraction separating performance occurs. In order to counteract the problems of electric flow turbulence as a result of electric wind, so-called two-stage electrostatic filters were developed, in which the charging and the separating of the particles occur in successively switched separated electric fields. The problematic aspect is the necessary spatial separation of the stages and their different electric high-voltage supply.

In order to solve this problem, an electrostatically working separator for dedusting industrial waste gases is known which works with a negative corona system. A method is known in particular in which particles difficult to separate are removed from a gas fluid with the help of electrostatic charging and separating by means of only one high-voltage source for a high-voltage zone. In contrast to the so-called Cottrell electrostatic filters, the particles are ionized successively and not simultaneously within the high-voltage zone and are thus separated. Moreover, a larger geometrical duct distance is in the ionization zone in this method and in these apparatuses than in the separating zone, as a result of which the field strength of the ionization zone is lower than the field strength of the separating zone. It has thus been managed to substantially avoid the disadvantages of electric turbulence. The duct width for the ionization zone was therefore provided with a larger arrangement in the known filters than the duct width of the separating zone because it was expected that in the comparatively small charging or ionization zone the expected very high, but necessary specific current flow would lead to a relatively early occurring sparkover activity which thus would limit the electric power. This means therefore that in the known filters an ionization zone is associated with at least two, but frequently even three and more separating zones. The presence of a sufficiently high field strength is ensured in the separating zone by the reduction of the duct width.

Similarly working air filters are known from the state of the art, even for purifying breathing air, which are used especially in households, restaurants and lecture halls. Air filters and industrial filters cannot be compared with each other because air filters need to fulfill completely different preconditions than the large industrial electrostatic filters which are concerned here. As a result, they cannot be used for cleaning industrial gases. Duct widths of 200 to 500 mm are usually used in electrostatic filters for industrial waste gases for example. This leads to the consequence, in combination with the composition of the exhaust gases and their flue-gas temperature, that field strengths in the range of 2 to 4 kV/cm and specific currents in the range of 0.2 to 1.2 mA/ml are usually used in industrial electrostatic filters.

Air filters are also known which each work with a positive corona system and two high voltages. These air filters comprise a rectifier with two outputs for ionization and separation. The field strengths in the known air filters are the same in the ionization and separation zone, but are provided with different voltage potentials. Both zones must be provided with a configuration so as to electrically insulated from each other. Moreover, positive discharge electrodes are provided in the known filters in the ionization zone, which electrodes produce a moderate ionization.

Before the background of ever rising demands placed on the energy efficiency of industrial appliances, the invention is based on the object of avoiding the disadvantages of the described electrostatic filters and electrostatic filter methods and to reduce the energy input in the filtering of industrial waste gases.

This object is achieved in accordance with the invention by the method according to claim 1 and the apparatus according to claim 5. Preferred further developments of the method and the apparatus are described in the subclaims.

The separator in accordance with the invention and the separating method in accordance with the invention therefore work with a negative corona system, in which a just sufficient charging of the particles is carried out in each high-voltage zone with the help of only one high-voltage source. The transport of the charged particles and their separation therefore occurs at the lowest additional energy input at the oppositely polarized collecting electrodes, with the individual ducts known from conventional filters with negative corona systems remaining unchanged.

This means that in a region of extreme ionization with a respectively high electric turbulence and electric wind transversally to the gas flow a substantially calmed and virtually laminar region follows substantially without any electric turbulence, in which the separation of the charged particles that are difficult to separate can occur in a highly efficient and unhindered manner.

The efficient charging of the particles which occurs as complete as possible is performed with applied high voltage in the ionization zone, which on its part generates a field strength in the subsequent separating zone at lowest possible current which is sufficient for the transport and separation of the particles. A low defined current in the separating zone ensures that a certain follow-up guidance of charge carriers to the positive collecting electrode is achieved in order to substantially prevent the repeated swirling (re-entrainment) of already separated particles.

This is principally realized for different embodiments of electrostatic filters in such a way that in the individual ducts of the high-voltage zone with unchanged duct distance extremely different corona discharge distances are used in the ionization zone and in the separation zone by highly current-intensive or current-suppressing electrode shapes on a common high-voltage source, with the principle of the larger geometric corona discharge distance in the ionization zone and the lower geometric corona discharge distance in the separation zone being set to the highest extent. It is now possible to keep constant the duct width of the individual ducts, so that each ionization zone is associated with only one separation zone. Moreover, the sparkover activity does not start or only starts at such a late time that the electric power is not reduced substantially.

It is optionally possible to successively arrange several sections for ionization and separation within an electrostatic field when the single particle charge should prove to be insufficient.

Several embodiments of the invention will be explained below in closer detail by reference to figures and diagrams shown schematically in the drawings, wherein:

FIG. 1 shows the particle separating behavior in an electrostatic filter;

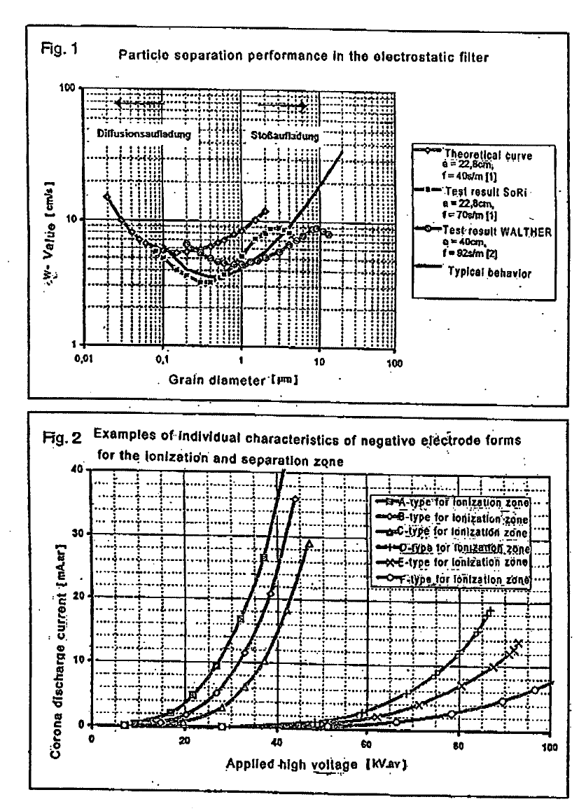

FIG. 2 shows examples of the typical electric characteristic performance of the negative electrode shapes for the ionization zone and the separation zone of the method in accordance with the invention;

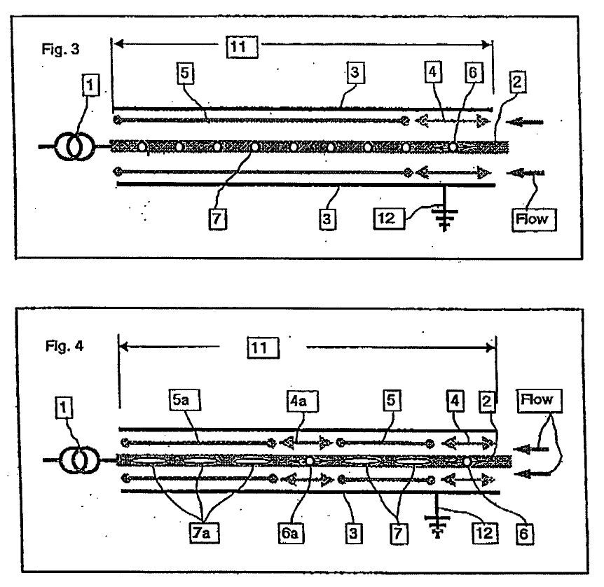

FIG. 3 shows a layout plan of a first embodiment of an individual separation duct of the separation apparatus in accordance with the invention;

FIG. 4 shows a layout plan of a second embodiment of an individual separation duct of the separation apparatus in accordance with the invention;

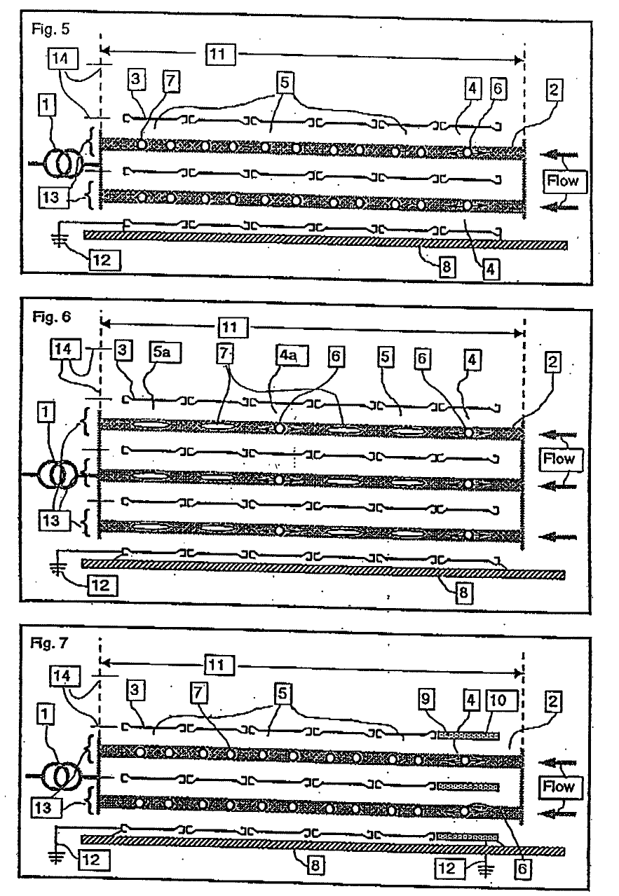

FIG. 5 shows a first embodiment of an electrostatic filter in accordance with the invention with two separating ducts and one ionization zone;

FIG. 6 shows a second embodiment of an electrostatic filter in accordance with the invention with three separating ducts and two ionization zones;

FIG. 7 shows a third embodiment of an electrostatic filter in accordance with the invention with two separating ducts with cooled collecting electrodes in the ionization zone.

FIG. 1 shows the particle separation behavior in an electrostatic filter. As a result of the physically effective charging mechanisms, i.e. the so-called surge or field charging and the diffusion charging, there is a more or less marked minimum of the particle fraction separation performance. This can clearly be seen in all illustrated curves.

FIG. 2 shows the amount to which the individual characteristics of the negative electrode geometries in question need to differ from each other so that the object in accordance with the invention can be achieved. The characteristics on the left part of the diagram correspond to the highly current-drawing electrode shapes (Type A, B and C) for the ionization zone, whereas the characteristics shown in the right part of the diagram correspond to the low-current electrode shapes (Type D, E and F) for the separation zone.

FIG. 3 shows an overview of a single separation duct with the work sections of ionizing and separating. Adjacent analogous ducts are not shown. A high-voltage system 2 is connected to a high-voltage power source 1, which system is provided with current-intensive discharge electrodes 6 and voltage-intensive or low-current negative electrodes 7. The discharge electrodes 6 are situated in an ionization zone 4 which is formed by the collecting electrodes 6 grounded with reference numeral 12. The negative electrodes 7 are situated in a separation zone 5 which is also formed by the collecting electrodes 3. The entire high-voltage zone is marked with reference numeral 11. In the ionizing zone 4 which is also known as ionization zone, a sufficient charging of the particles is achieved which are then separated optimally in the following separation zone 5 with strongly reduced turbulences and virtually missing electric wind.

When the single particle charging in a high-voltage zone is insufficient for optimal separation, a further ionization region 4a with a separation zone 5a can be provided downstream of the ionization zone 4 and the separation zone 5.

FIG. 5 shows a schematic illustration of a horizontally arranged electrostatic filter, a so-called horizontal field. Several rows of collecting electrodes 3 are provided here within a filter housing 8 with grounding 12, which electrodes form several separation ducts 13 which on their part comprise an ionization zone 4 with the current-intensive discharge electrodes 6 and a separation zone with low-current negative electrodes 7. The embodiment shown here comprises two separation ducts 13. Further separation ducts 13 can be connected, as is indicated with the broken lines 14.

FIG. 6 shows a further embodiment of the electrostatic filter in accordance with the invention, with two ionization zones 4 and 4a and two separation zones 5 and 5a being arranged within the three illustrated separation ducts 13. Furthermore, with their elliptical form the negative electrodes 7 shown in FIG. 6 have another possible geometry.

FIG. 7 shows a third embodiment with an ionization zone 4, in which the collecting electrodes grounded with reference numeral 12 are arranged as hollow bodies (cooling chamber 10) which is flowed through by a coolant 9. This cooling helps prevent a re-ionization which is also known as back corona as a result of an extreme electric resistance of separated particles in the ionization zone 4.

The nature of the invention is clearly shown in the principal illustrations, namely to perform within a high-voltage zone 11 with its unchanged individual ducts 13 with only one high-voltage supply source 1 an optimal electric charging or ionization in the ionization zone 4, 4a and to ensure the subsequent particle separation in the separation zone 5, 5a at sufficient field strength.

1. A method for separating dusts from industrial waste gases, in which particles which are difficult to separate are removed from a gas fluid with the help of electrostatic charging and separation by means of only one high-voltage supply source for a high-voltage zone, with the particles being successively ionized and separated within the high-voltage zone, and in which the particles being ionized and separated both in the ionization zone as well as in the separation zone by connected negative electrodes which are connected to only one high-voltage supply source with only one output, wherein the high-voltage zone comprises one or several individual ducts of even duct width, in which the particles are successively ionized and separated, and that by suitable choice of the negative electrode geometry for the ionization and separation zone a substantially higher current flow is generated in the ionization zone than in the separation zone.

2. A method according to claim 1, wherein the particles are ionized and separated twice or several times successively with the individual ducts of the high-voltage zone in the manner of a series connection.

3. A method according to claim 1, wherein the particles of the fluid to be cleaned are charged within the individual ducts by the applied negative high voltage in the ionization zones with at least 10 times the current flow as compared with the separation zone.

4. A method according to claim 1, wherein the grounded electrodes of the ionization zone are cooled.

5. An electrically working filter for separating dusts from industrial waste gases for performing the method according to claim 1, comprising a high-voltage zone with individual ducts which comprise an ionization zone with a downstream separation zone each, wherein the filter comprises one or several high-voltage zones, with each of said zones being provided with a high-voltage supply source and with both the ionization zones as well as the separation zones each being provided with different negative electrodes which are connected in a joined manner to a high-voltage supply source with only one output.

6. An apparatus according to claim 5, wherein the negative electrodes are arranged in the ionization zones and the separation zones by suitable geometrical arrangement in such a way that a corona discharge current of at least ten times as compared with the separation zones is generated in the ionization zones.

7. An apparatus according to claim 5, wherein the geometries of the negatively polarized electrodes for the ionization zone and the separation zone are provided with different configurations, with high-current-intensive corona discharge electrode forms being used for the ionization zone and substantially low-current or voltage-intensive negative electrode forms being used for the separation zone.

8. An apparatus according to claim 5, wherein several ionization zones and separation zones are arranged in the direction of flow of the fluids behind one another in a high-voltage zone in the individual ducts.

9. An apparatus according to claim 5, wherein the collecting electrodes of the ionization zone are provided with cooling chambers.
